(19) United States
(12) Patent Application Publication
(10) Pub. No.: US 2007/0156421 A1
(43) Pub. Date: Jul. 5, 2007

(54) Training using simulated work environment

(76) Inventor: Brian Klapper, New Canaan, CT (US)

Correspondence Address: ST. ONGE STEWARD JOHNSTON & REENS, LLC, 986 BEDFORD STREET, STAMFORD, CT, 06905-5619, US

(21) Appl. No.: 11/321,861

(22) Filed: Dec. 29, 2005

(51) Int. Cl. G06Q 99/00

(52) U.S. Cl. 705/1

(57) ABSTRACT

A simulated work environment for teaching business skills to participants through a fictional company with organizational roles filled by the participants, information about the initial status of the company, a communication link through which the participants can be given information or communicate, and an objective that the participants must achieve within the simulated work environment.

### FIELD OF THE INVENTION

The invention relates to training business management and, more particularly, to training business management in techniques utilizing an environment that simulates business conditions.

### BACKGROUND OF THE INVENTION

In today's business environment, companies are continuously seeking to improve their organization's performance. Many will consult with experts to help develop new products, adapt the company to a changing business environment, and improve operations. Some of these consultants transfer a prepackaged solution to their customers. Others employ skills which enable them to study and refine the business methods and operations of a company. Essentially, companies are outsourcing the job of problem solving.

These consultants will study the business's operations, determine its strengths and weaknesses, and submit a plan for management to implement. They may provide the company with a new business strategy, design a new process, help produce innovative new products and/or services, improve operations, redesign the organizational structure, or assist in production planning and inventory management. This method has many deficiencies. First, since every business is different, the consultant will lack the intimate knowledge of a business's operations and culture. This places the consultant at a disadvantage of trying to efficiently and effectively identify the root cause and correct the various problems that plague the business. Second, this method is deficient because it requires a management team to implement a solution for the first time with their company. This leaves little room for error. Third, generally these plans are geared towards addressing an immediate problem and will not provide tools that will enable a company to adapt to changing circumstances. Fourth, traditional management consulting does not provide the knowledge transfer needed to allow the companies to solve their own business problems and learn how to take advantage of marketplace opportunities without the need for ongoing consulting support.

What is needed is a system and method that transfers to a management team the skills typically possessed by industry experts. This would provide a company with the ability to recognize and address its own problems, modify its solution overtime and enhance its overall effectiveness. Such a transfer would be most effective if a management team were supplied with the necessary skills and then provided with a risk-free, yet very realistic environment to gain experience utilizing those skills. Based on the experience gained in such an environment, the team could then utilize those tools with their own company. The transfer would also be enhanced if the team could be subjected to repetitive real life experiences so that they can better understand the nuances of what they are being taught. This could be achieved utilizing a controlled environment where the results can be easily evaluated. However, abstract principals of management and organization are typically learned over time. To accelerate the transfer of skills, a simulated environment can be used to enable the participants to gain an understanding of these principals in a compressed format. Overall, what is needed is an environment that enables a management organization to learn how to conceptualize a problem, develop a plan to address the problem and implement a plan to resolve the problem.

### SUMMARY OF THE INVENTION

These and other objects are achieved by providing a system and method utilizing a simulated work environment to educate and install skills in a management team.

In one advantageous embodiment of the present invention, the simulated work environment utilizes a plurality of participants, a business entity, which has a plurality of organizational roles filled by the participants, an information packet providing initial information about the company, a communication link that may allow the participants to receive information or communicate between each other, and an education module providing an objective.

The system can also incorporate an education venue within which the participants interact, an intranet or internet system to act as an information resource for the participants, and a skill set providing a method for achieving the objective.

It is another aspect of this invention for the system to help educate the participants on methods for developing a strategic plan, innovating a solution to transform a company or product, or improving the operations of a company.

Further, this system can provide an education module that first utilizes the participants' method for achieving the objective and second provides participants' with an alternative method to execute. By comparing the results of the first method to the second method, the participants can be shown the benefits of the second method.

It is further contemplated that the system provides information on competitors and customers in the market.

It is yet another aspect of the present invention to provide a method for teaching business skills by providing a plurality of participants, providing a business entity, which comprises organizational roles to be filled by the participants, providing initial information about the entity, providing a communication link through which the participants are given information or can communicate between each other, and providing an education module that comprises an objective.

Other objects of the invention and its particular features and advantages will become more apparent from consideration of the following drawings and accompanying description.

### BRIEF DESCRIPTION OF THE DRAWINGS

FIG. 1A is a depiction of a system utilized to educate a management team in a simulated work environment.

FIG. 1B is a depiction of a process utilizing the simulated work environment to educate participants on developing a strategic plan.

FIG. 1C is a depiction of a process utilizing the simulated work environment to educate participants on transforming a product or company.

FIG. 1D is a depiction of a process utilizing the simulated work environment to educate participants on methods to enhance a company's operations.

### DETAILED DESCRIPTION OF THE INVENTION

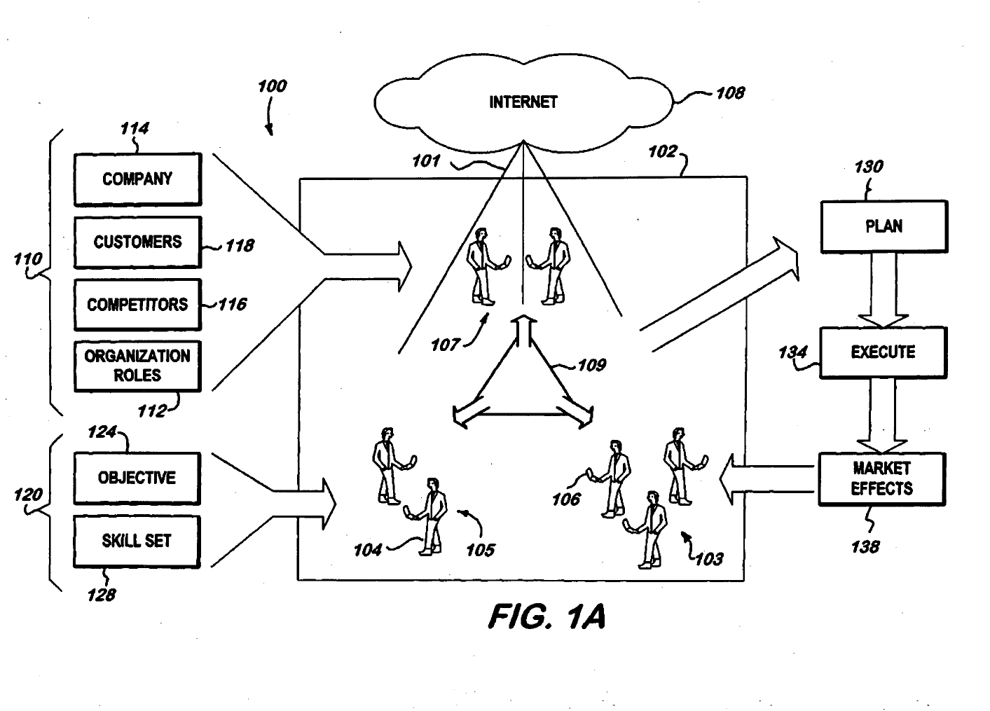

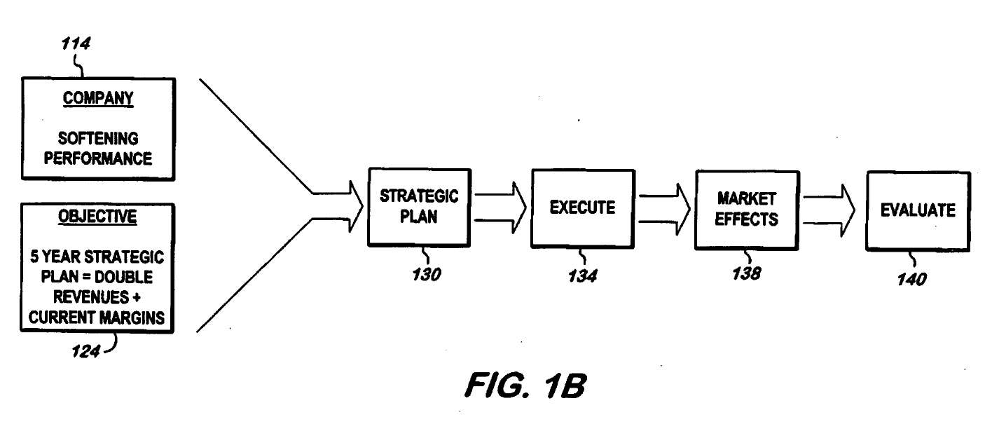

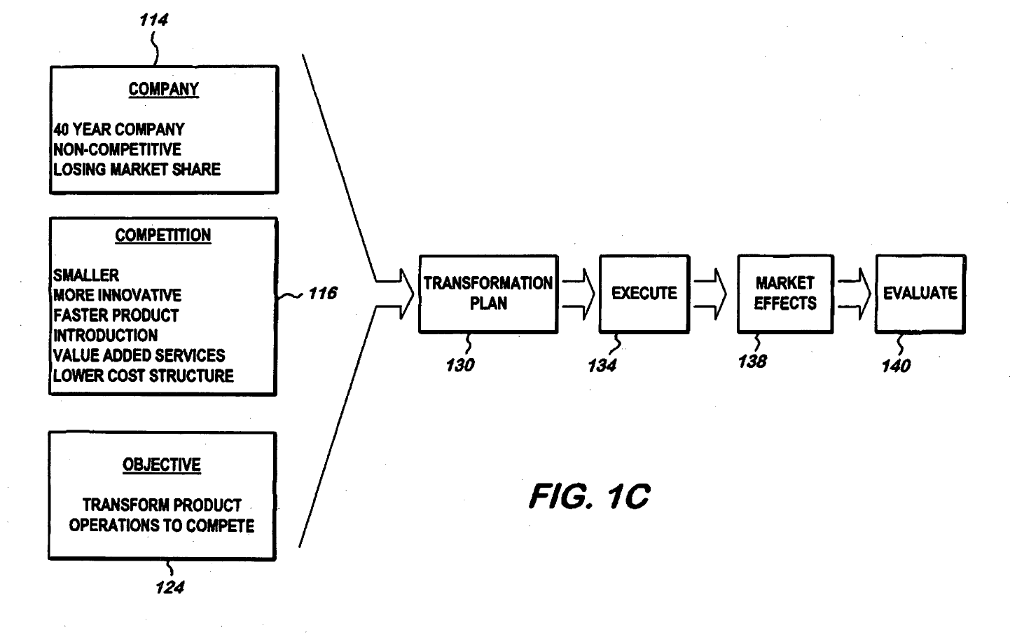

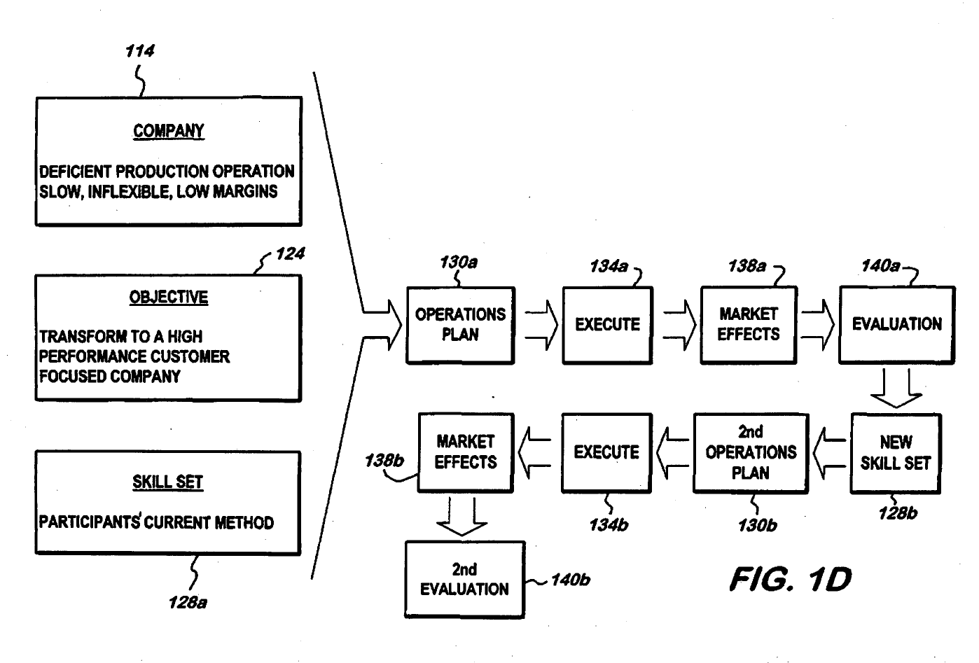

A simulated work environment 100 is employed as shown in FIG. 1A. The environment 100 is used to provide participants 104 from a management team with new skills to help further their business objectives. This environment 100 provides an education venue 102 in which participants 104 interact. These participants 104 are given information 110 on a company 114, such as a fictional business entity that provides a product or service to customers in a market place. Company 114 designs, manufactures, and markets its products worldwide. Each participant 104 can be provided with a device 106, such as a personal data assistant (PDA), through which participants 104 can communicate 109 or be given information. The device 106 also gives participants 104 access to an intranet or internet system 108. The system 108 can be used to supply participants 104 with information as the simulation 100 progresses. The internet/intranet system 108 can also be used as a resource for participants 104 to gain access to necessary information 101. Finally, the environment 100 provides the participants 104 with an education module 120. The module 120 provides the participants 104 with a business objective 124 and a set of skills 128 to achieve objective 124.

Participants 104 are provided information 110. The information 110 provides background and initial information on company 114, its competitors 116, its customers 118, and its organizational structure 112. The participants 104 occupy the roles established in the organizational structure 112. The participants 104 are then provided with an. education module 120. The education module 120 provides each participant 104 with a business objective 124 and a set of skills 128 to achieve objective 124. With the information 110 and the education module 120, the participants 104 interact to develop a business plan 130. The particular business plan 130 depends on the objective 124 of education module 120. The participants 104 then execute 134 plan 130 in the simulated work environment 100. The execution 134 of plan 130 produces a market effect 138. The market effect 138 is then evaluated by the participants 104 to assess the effectiveness of plan 130 in achieving objective 124. If necessary, participants 104 will redo the process and develop a new plan 130, execute 134 the new plan 130, determine the market effects 138, and evaluate its effectiveness. This has the benefit of assisting participants 104 in developing a better understanding of the nuances of skill set 128 in achieving objective 124.

The information 110 constitutes initial status information on company 114. Such information 110 could include an annual report detailing the fundamentals of company 114, a welcome letter from the CEO detailing the objectives for participants 104, organizational information 112 detailing the roles that participants 104 will fill, and a job description directed to each individual participant 104 about their function in company 110.

It is beneficial if the education venue 102 is a real time environment. This helps facilitate the participants' 104 ability to apply their newly acquired skills on their feet. The real time experience is further improved if the participants 104 undergo the experience in a face to face setting. This enhances the interaction between participants 104 and their ability to exchange ideas in developing and executing plan 130.

The educational experience is further enhanced when each participant 104 is supplied with a communication device 106. The communication device 106 could be a computer at a work station, a PDA, a role book, cell phone or other device through which information is provided to the participant. Through the device 106, the participants 104 can gain access to information necessary to aid them in addressing the company's 114 problems. This may include information on customers 118, competitors 116, or the changing conditions of the market available through an intranet or internet. Device 106 can also be used as a means to establish an inter-participant link 109. When utilizing a computer, PDA or cell phone, participants 104 are able to interact through multiple lines of communication. The participants 104 can record ideas and share them with each other through device 106. It also enables participants 104 to form separate operational groups 103, 105, 107 each assigned with a different task. Each participant 104 can monitor the progress of other participants 104 and their groups through device 106. This will help give the participants 104 the feel of working with an evolving process. For instance, group 107 would represent the leadership roles, instructing groups 103 and 105 on their work. Group 103 could provide information on its progress to group 107 who can then instruct group 105 on how to alter their performance. This enables the participants 104 to accelerate the overall productivity while still benefiting from the knowledge gained by the participants 104 in the other groups. It also facilitates a dynamic in which group 107 is able to supervise and coordinate the activities of group 103 and group 105. Organization and communication through these groups also helps replicate work conditions. The device 106 can also provide participants 104 with greater information about company 114, competitors 116, and customers 118. This information can be stored in device 106 or provided through the intranet or internet 108. Device 106 also facilitates the ability to provide additional or real time information on the changing circumstances of competitors 116 and customers 118.

The education module 120 is used to provide participants 104 with a scenario that participants 104 must address. FIG. 1B shows a scenario that requires participants 104 to develop a strategic plan 130 and then implement 134 that plan. The strategic plan 130 scenario provides a company 114 that is softening in its key business segments. Participants 104 are given the objective 124 of creating and implementing a strategic plan 130 that, over the next five years, doubles revenues while maintaining current margin levels. Through the simulated environment 100, participants 104 establish a plan 130 to articulate a mission, vision and fundamental values for company 114; identify potential areas for growth and evaluate each for potential risks and opportunities; assess current and future goals of specified customer segments; categorize the market segments according to customers' requirements, their historical behavior patterns and their socioeconomic profiles; identify the advantages and disadvantages of company 114 relative to a competitor and determine how to overcome the disadvantages; develop a business model; or establish business goals. To do so, the participants are assigned to different groups each given a distinct objective and instructed to gather information on the market, customers, and competition. Each group will then make a presentation to those participants that comprise the board of directors. The board will then be called on to approve or disapprove each proposal. Based on the plan selected, the participants 104 will then execute 134 their strategic plan 130 and are given feedback on the success of their plan in the market 138. The participants 104 are then able to evaluate their success and undergo the process once again in order to find a better solution. By implementing, reviewing, and repeating the process, participants 104 obtain a deeper understanding of the strategic planning process.

FIG. 1C shows a scenario in which education module 120 is used to develop skills in innovation. The objective is for the participants to learn how to build a culture of innovation and all of the necessary components that must be in place to transform a business to become more innovative for its products, services or operations. The participants 104 are provided with a product or company 114 with a 40-year track record, but are no longer competitive. The company 114 is facing new competitive intensity from smaller, more innovative firms 116. As a result, company 114 is losing market share to these firms 116, who offer faster product introductions, value-added services, and do so with a lower cost structure. The participants 104 are given the objective 124 of transforming company's 114 product, services or operations. Such an objective 124 requires participants 104 to transform company 114 from a slow, inflexible, conservative firm into a dynamic, fast-paced organization that thrives on experimentation, rapid piloting and innovation. The participants 104 are given the option of innovating a new business model, a new process for manufacturing, or a new product or service.

To accomplish this objective, the participants 104 will be given a skill set called the innovation loop. This skill set teaches the participants on how to prepare their organization for an innovative culture; how to enlist a team that will be tasked with developing innovative solutions; how to understand the nature of the problem through analyzing and observing the market and customers; how to develop ideas; how to develop prototypes to test the feasibility of an idea; how to plan for and test a prototype in an actual operating environment; and how to implement a successful innovation plan through developing a roll-out plan, implementing a full-scale roll out, and monitoring the process. Preparation requires the participants to eliminate obstacles to creativity, such as time pressure, organizational impediments and political issues; to enhance the stimulants to creativity, such as freedom, positive challenge to the work, providing sufficient resources, supervisory encouragement, and organizational encouragement; to provide focus and prioritization to innovation categories; and to be willing to challenge a company's embedded paradigms. A team is enlisted with a goal of maximizing creativity. This is accomplished by drawing on participants with different skills, such as logical, linguistic, spatial, kinesthetic, interpersonal, and intrapersonal. It is also important to identify people with the ability to keep an eye on the big picture, that are pragmatist, that can act as a devil's advocate by challenging the status quo, that represent the interests of the customer, that are able to follow through on an innovation idea, that are an expert on the capabilities of technology, and that are skilled in making money out of an idea. Understanding requires the participants to monitor the top 10 performers in the area at issue, to focus on strange occurrences, to monitor the customer's environment, to identify things that don't make sense, to question why certain phenomena exist, and to focus on sustainable trends, not fads. When attempting to understand an industry it is important to identify the attributes that should be reduced below the industry standard; the attributes that should be eliminated and only exist because the industry has taken them for granted; the attributes that are overlooked by the industry; and the attributes that should be raised above the industry standard. Identifying top performers should be done by looking for good ides; identifying the most sophisticated users of these ideas; understanding how they solve their problems; determine whether their idea improves a feature through cost, size, or price, or creates a novel item; and identify those pieces of products, practices or technologies that can be recombined in novel ways to solve customer problems. Ideas are developed through brainstorming, screening and prioritizing. When brainstorming, the participants are expected to create a large number of ideas; not to limit their ideas to what is considered reasonable; to be willing to build on the ideas of others; not to determine the effectiveness of an idea during the brainstorming process; to focus on addressing the issue at hand; and to limit the discussion to one idea at a time. The participants can also be instructed on how to engage in the brainstorming process. The participants will assemble an appropriate group, find a venue to engage in brainstorming, gather necessary materials to facilitate the discussion, establish a time limit to discuss each idea (such as 30 minutes), begin the process with a concise statement of the issue to be resolved, review the rules of brainstorming, and rewrite/organize the ideas at the completion of the process. The ideas are then screened and prioritized by determining which ideas create the greatest likelihood for disruptive growth. Each idea is evaluated to determine if it addresses over served, underserved, or unsatisfied customers; if it creates a new business model; and if the idea takes advantage of competitors' weaknesses or blind spots. They can also be prioritized by rating the ideas against the objectives, a vote of the participants, ranking and weighing each idea, evaluating the upside and downside of each idea, or mixing and matching compatible ideas. If it is feasible, the participants can simply try them all. A prototype can be developed by defining a small, practical test in a page or less of text, gathering cheap materials to develop the prototype, maximizing the ratio of learning over investment, finding a partner-customer who can provide a test site and act as a sounding board, set a deadline of one week to develop the test, conduct the test, de-brief and record results, determine what was learned from the test, and incorporate what was learned and rerun the test. When an innovation plan is identified, it can be implemented by creating a small corporate-level organization to promote the effort; the use of small pilot projects to build support for ideas; ensuring that major management processes do not interfere with innovation; identifying and reducing major risk categories such as market risk, technology risk, implementation risk, and competitive risk; and determining where the innovation should fit within the organization. Utilizing the above identified steps of the innovation loop will help an organization develop an innovation culture.

Through the participants 104 efforts in innovation, they can establish a plan 130 to reorganize the structure of company 114; design an experiment to test an idea quickly and at a low cost; establish performance metrics; benchmark competitors 116 on innovation effectiveness; adapt the company's 114 operational capabilities to foster innovation; develop a prototype and test a new product; create a value added service; develop a new operational process; or measure the effectiveness of an innovation. The participants 104 then execute 134 their ideas to change the products, services or operations, and are given feedback on the success of their plan in the market 138. The participants 104 are then able to evaluate 140 their success and redo the process in order to find a better solution. By implementing, reviewing, and repeating the process, participants 104 obtain a deeper understanding of the process for innovating new products, services or operations.

FIG. 1D shows a scenario in which participants 104 are given the objective of enhancing the operations of company 114. Company 114 has an operationally deficient production environment. The participants 104 are given the objective of identifying the root cause and resolving this problem. Participants 104 are required to transform a company 114 from a slow, inflexible, low margin operation into a high performance, customer-focused company. Participants 104 are given control of company's 114 operating functions such as Operations, Sales, Service, Finance, Engineering, Human Resources, and Corporate Administration. First, the participants 104 utilize their own problem-solving techniques 128a. The participants 104 undergo the process of developing a plan 130a, executing the plan 134a, receiving input on the market effects 138a, and evaluating 140a its performance. The participants 104 can then be shown that their traditional approach to problem solving is inefficient or ineffective and be presented with an alternative approach to resolve the issue 128b. The participants 104 can be shown how to listen to both customer and business needs through interviewing customers, key stakeholders, analyzing past research and documents, and assessing competitor positioning. The participants 104 can learn how to understand their current processes, analyze their performance, hypothesize potential root causes, and conduct experiments to validate the hypothesis. Finally, the participants 104 can launch a series of rapid prototypes or pilots, followed by a carefully coordinated rollout and detailed monitoring. The participants 104 can then use the alternative method 128b, develop a second plan 130b, execute that plan 134b, receive input on its effects 138b, and evaluate 140b their performance.

The simulated work environment can be used to help participants develop additional skill sets. This environment can be used to teach participants on how to develop skills in change management, organizational development/design, effective leadership, knowledge transfer and preparing for a large-scale systems implementation.

One method to evaluate the performance of the participants in developing and implementing a plan is to utilize an employee survey. This survey can call on the employees to rate their satisfaction with a number of categories. These could include satisfaction with the group's performance, the problem solving methods, the plan developed and the ability of the group to implement the plan. Since the employees are tasked with utilizing and implementing a problem solving skill set, they will possess the most intimate knowledge of what works and what doesn't. With the introduction of a new skill set to the participants, the employee survey can be used as an effective tool to gauge the ability of the group to grasp the new skill set. This survey can be conducted at the beginning of the simulation to gauge each participant's satisfaction with their company's established methods. Since the participants are engaged in the simulation to improve the ability of the group to address problems, the overall satisfaction is likely to be low. Each time the simulation is performed the survey can be taken. As the participants adopt and implement each new skill set, the participants' satisfaction with their mastery of the skill set and the implementation of the plan should improve. To help illustrate the satisfaction of the participants as their skills improve, a picture comprising primary colors can be utilized. This image can be produced on a display for all participants to see. A computer program scrambles the image based on the ratings received from the employee survey. When low employee satisfaction numbers are entered into the computer, the computer outputs a highly scrambled image such that a brown image is produced. With increasing employee satisfaction, the computer unscrambles the image. When the survey returns near perfect satisfaction, an image of bold primary colors is displayed for the participants. This helps illustrate the progress the participants make in adopting the new skill set. Overall, the use of the survey provides another metric in which to gauge the performance of the participants.

As participants 104 undergo the planning 130 and execution 134 stages, they can be provided with revised information on competitors 116 and customers 118. This information is valuable because it assists the participants 104 in understanding the dynamics of the overall market and the effects of their decisions on the market. Further, providing fluid information about changing conditions may force participants 104 to adapt or change their plan 130 to achieve objective 124. This is beneficial because it helps develop an understanding about the value of flexibility.

An embodiment of the foregoing invention is provided by the following example of the above described system and methods. A group of participants 104 are officers and managers within their own organization and are interested in improving their company's operations. Instead of trying to employ an expert in the field of enhancing operations, this group will be taught how to evaluate and implement such an improvement on their own. Over a weekend this group will be brought to education venue 102, such as a hotel convention room. The room will contain work stations and assembly lines for the participants to occupy. It will also contain information displays, such as flat panel screens. These displays will be used to project a broadcast, such as a television news show, that will inform the participants about the state of the market. The information conveyed from the broadcast will be tailored to respond to the actions of the participants during the simulation. This will enable the participants to gauge the effectiveness of their efforts and their overall competitiveness based on this feedback.

At the beginning of the process, the participants will take an employee survey in which they rate their satisfaction in categories such as their company' performance, their problem solving methods, their plans developed thus far and their ability to implement those plans. Next, the participants will be introduced to a fictional company 114. They will be presented with an information packet that includes a welcome letter from the CEO of the company, an annual report, a job description, a benefits package, preliminary information on the customer support division of the company, and preliminary information on product manufactured by the company. The packet will inform the participants that they will be occupying a division within the company that is responsible for sales, manufacturing, engineering, and finances for this company's product. The annual report will tell the participants about the company's performance in the past and objectives for the future. The job description will assign each participant a role in the company, such as human resources director. It will instruct each participant as to the role that they will play, what their responsibility is, where they fit in the divisions' greater structure, and establish objectives for the participant over the next simulated year. The product will be a technology that the participants are not readily familiar with, such as a gyroscope guidance system. The participants will be given a brief presentation on the technology and its functions. This will be important during the latter stages of the experience when the participants need to trouble shoot defects and provide solutions. Further, the group will be provided with information on the state of the market that company 114 participates in through information on the company's 114 competitors 116 and customers 118. The objective of this information is not simply to provide the participants with the necessary information to achieve the objective. It is also intended to immerse the participants in a business environment that they are familiar with. As will be detailed below, the experience and educational value is enhanced when the participants are more willing and comfortable to address problems in the manner traditionally employed by their company.

Different stations are set up through out the education venue. Many participants will occupy work stations much like their own desk at their office. A participant representing the sales department will field calls from prospective customers and take orders. The participant will be responsible for entering orders into a networked computer system. The information is passed on to other participants within the division such as the manufacturing group. The members of the manufacturing group are responsible for assembling and delivering the division's product. These members will be required to devise a strategy on how to assemble the device and deliver it to the customer. The participants will continue to undergo this process of receiving orders and shipping the product to their customers. However during the course of this simulation, customers will begin to return products that don't meet specification or are otherwise defective. This is due to the fact that there is an inherent defect in the technology. The number of returns will escalate to the point that it becomes apparent that there is a flaw in the product.

Now the participants 104 will be tasked with identifying and resolving this problem. They will also be instructed to approach this issue in the manner that is traditionally employed by their own company. The team will organize, divide their labor, and address the problem in their traditional manner. The participants will be able to gather data on the product and the issues at hand. The participants will present to each other their findings and the group will discuss the problem. The group will attempt to identify the root cause, either through identifying a defect in the manufacturing process or the technology itself. The group will reach a solution and place the solution into practice. The simulation will begin once again with orders being taken and products delivered. For a period of time it will appear that the group's solution has addressed the problem. However, the flaws to their solution will inevitably crop up and customer dissatisfaction will once again be an issue.

At this point the simulation will stop again. Once again, the participants will be called on to complete an employee survey to measure their satisfaction with their performance in the simulation. The participants 104 can be shown the pros and cons of their plan and execution. With this knowledge, the participants 104 can be shown a new skill set for resolving a company's problem. They will be taught new methods for identifying problems, creating solutions, and implementing those solutions. For instance, they can be taught how to listen to their customer's needs and the requirements of their business. They can also be taught how to hypothesize as to the route cause of their problems and develop experiments to resolve the problem. Further, they can be taught how to develop pilot programs that encompass a solution, implement that solution, and then monitor its results. The participants 104 will then be given a first opportunity to try to utilize the new skill set. They will be coached through the process of listening, learning, and launching. After the completion of the simulation with the new skill set, the employees will once again complete an employee survey. It is expected that this survey will show that the skill set will increase the satisfaction of the participants in the group's ability to resolve operations problems. However, since the group cannot seamlessly implement the new skill set, room for improvement should also be reflected.

The participants 104 will again participate in the simulator by addressing the problems of the deficient company 114. In the second simulation, participants 104 may be required to redress the original problem, address a new operations problem within the same company, or be presented with a new company and a completely different operations problem. Once again, the participants 104 will organize within education venue 102 utilizing skill set 128. They will interact within their groups 103, 105, 107, communicate with PDAs 106, and draw on and obtain updated information through PDAs 106. During this time, the participants will generate and implement a plan to address the operations problem utilizing skill set 128. Since this method is new to them, they will not be familiar with how to effectively use it and will be slow in bringing about a solution. As the simulation progresses the participants 104 will gain their legs with their increased familiarity with the new technique. Once the second plan is implemented, the participants will be given feedback as before. They can compare their performance from the second time to the first time. They can evaluate how their second performance improved the productivity of the company, its position relative to its competitors, and its ability to address its customer's needs. They can also evaluate how effectively they implemented the new skill set 128. The participants 104 can be shown how their techniques utilizing the skill set can be improved, alternative solutions that the skill set 128 would have allowed them to achieve, and potentially new problems that need to be addressed. As before, an employee survey is taken and should demonstrate improved satisfaction with the ability of the group to address operations problems and their satisfaction with their use of the new skill set. The participants 104 will then be required to undergo the simulation again. The ability to transfer a new skill set and a new manner for addressing problems is greatly improved with repetition. During the course of the weekend the participants will run the simulated business three times and potentially more, depending on their ability to adopt and implement the new skill set. The number of simulations may be dictated by the feedback from each employee survey and a desire to achieve near perfect satisfaction.

Although the invention has been described with reference to a particular arrangement of parts, features, and the like, these are not intended to exhaust all possible arrangements or features, and indeed many modifications and variations will be ascertainable to those of skill in the art.

What is claimed is:

1. A system for teaching business skills comprising:
a plurality of participants;
a simulated company;
said company comprising a plurality of organizational roles to be filled by said participants;
an information packet providing initial information about said company to said participants;
at least one communication link through which the participants are given information or communicate; and
an education module comprising an objective for said participants.

2. The system of claim 1 further comprising an education venue within which the participants interact.

3. The system of claim 1 wherein said information packet comprises a job description for each organizational role.

4. The system of claim 1 wherein said communication link comprises at least one personal data assistant.

5. The system of claim 4 wherein said communication link comprises access to an intranet or internet system.

6. The system of claim 1 wherein said education module further comprises a skill set for achieving said objective.

7. The system of claim 6 wherein said objective comprises developing a strategic plan.

8. The system of claims 7 wherein said participants implement said strategic plan.

9. The system of claim 8 wherein said participants articulate said company's mission, vision and fundamental values; or identify potential areas for growth and evaluate each for potential risks and opportunities; or assess current and future goals of specified customer segments; or categorize the market segments according to customers' requirements, their historical behavior patterns and their socioeconomic profiles; or identify the company's advantages and disadvantages relative to at least one competitor and determine how to overcome the disadvantages; or develop a business model; or establish business goals; or develop a plan to implement said strategy; or develop a plan to respond to contingencies or environmental changes; or develop a method for evaluating performance.

10. The system of claim 6 wherein said participants are given an objective of innovating a solution to transform the company, a product or a service.

11. The system of claim 10 wherein said company, product or service, is in an initial state and said initial state comprises competition from smaller firms; or competition from more innovative firms; or said company is losing market share; or at least one competing firm that offers faster product introductions; or at least one competing firm that provides value-added services; or at least one competing firm that has a lower cost structure.

12. The system of claim 11 wherein said participants reorganize the structure of said company; or design an experiment to test an idea quickly and at a low cost; or establish performance metrics; or benchmark at least one competitor on innovation effectiveness; or adapt said company's operational capabilities to foster innovation; or develop a prototype and test a new product; or create a value added service; or develop a new operational process; or measure effectiveness of an innovation.

13. The system of claim 6 wherein said participants are given an objective of improving an operations structure of the company.

14. The system of claim 13 wherein said participants identify a root cause to a deficient operations structure.

15. The system of claim 14 wherein said participants develop a solution to resolve the deficient operations structure.

16. The system of claim 13 wherein said participants improve said operations structure by interviewing at least one customer, or interviewing at least one key stakeholder, or analyzing a document relating to operations, or assessing at least one competitor's capability.

17. The system of claim 16 wherein said participants assess an initial operations process; or analyze the capability of said initial operations process; or determine a root cause for a deficient initial operations process; or conduct an experiment to validate said determination.

18. The system of claim 17 wherein said participants implement at least one prototype; or coordinate a rollout of an operational improvement; or monitor an implementation of an operational improvement.

19. The system of claim 6 wherein said education module is repeated at least once to facilitate improvement on performance.

20. The system of claim 1 wherein said objective is achieved by a method utilized by said participants.

21. The system of claim 20 wherein said objective is achieved by utilizing a skill set taught to said participants.

22. The system of claim 1 further comprising information on at least one competitor.

23. The system of claim 22 where in said competitor information is provided in real time.

24. The system of claim 1 further comprising information on at least one customer.

25. The system of claim 24 wherein said customer information is provided in real time.

26. The system of claim 6 wherein said objective comprises strategic planning and strategy development; or product, service and operational innovation; or operational excellence; or change management; principles of effective leadership; or knowledge transfer and management; organizational development; or preparing for a large-scale systems implementation.

27. The system of claim 1 further comprising an employee survey.

28. A method for teaching business skills comprising:
providing a plurality of participants;
providing a fictional company;
said company comprising a plurality of organizational roles to be filled by said participants;
providing initial information about said company to said participants;
providing a communication link through which the participants are given information or communicate; and
providing an education module comprising an objective for said participants.

29. The method of claim 28 further comprising providing an education venue within which the participants interact.

30. The method of claim 29 wherein said communication link comprises at least one personal data assistant.

31. The method of claim 30 wherein said objective is achieved by a method utilized by said participants.

32. The method of claim 31 further comprising educating said participants with a skill set to achieve said objective.

33. The method of claim 32 wherein said participants utilize said skill set to achieve said objective.

34. The method of claim 33 wherein said objective comprises strategic planning and strategy development; or product, service and operational innovation; or operational excellence; or change management; principles of effective leadership; or knowledge transfer and management; organizational development; or preparing for a large-scale systems implementation.

35. The method of claim 33 further comprising learning how to develop a strategic plan.

36. The method of claim 33 further comprising learning innovation.

37. The method of claim 33 further comprising learning effective business execution.

38. The method of claim 33 further comprising taking an employee survey.
